(19) United States
(12) Patent Application Publication
(10) Pub. No.: US 2008/0105688 A1
(43) Pub. Date: May 8, 2008

(54) Microwave Cooking Container With Separate Compartments For Crisping And Steaming

(76) Inventor: Gary L. Hopkins, Scottsburg, IN (US)

Correspondence Address: David W. Carrithers;Carrithers Law Office, One Paragon Centre, 6060 Dutchman's Lane, Suite 140, Louisville, KY, 40205, US

(21) Appl. No.: 10/578,134

(22) PCT Filed: May 12, 2004
(86) PCT No.: PCT/US04/14826

§ 371 Date: May 24, 2006

Related U.S. Application Data
(60) Provisional application No. 60/516,896, filed on Nov. 3, 2003.

(51) Int. Cl. A47J 27/04; H05B 6/80

(52) U.S. Cl. 220/573.1; 219/730

(57) ABSTRACT

A microwave cooking device 10 for crisping and steaming food is described. The device 10 includes at least one crisping compartment 14 and at least one steaming compartment 12. The crisping compartment 14 has a susceptor film incorporated in the volume defined in the interior of the crisping compartment 14. The steaming compartment 12 has at least one venting mechanism 22 to enable steam to escape at a certain pressure. The crisping and steaming compartments 12, 14 are surrounded by an outer packaging 30 including at least one aperture to enable moisture released from the compartments 12, 14 to escape the microwave cooking device 10. One embodiment has an outer packaging 30 including at least one peal away strip 32 to form an aperture in the outer packaging 30.

### CROSS-REFERENCE TO RELATED APPLICATION

This application claims the benefit of U.S. Provisional Application No. 60/516,896 filed Nov. 3, 2003 and is a continuation of PCT/US2004/014826 filed on May 12, 2004 both of which are incorporated by reference herein.

### BACKGROUND OF THE INVENTION

The present invention relates to the field of cooking devices, and, more particularly, to cooking containers for use in a microwave oven for cooking meats, vegetables, and other food products.

Consumers often prefer to cook food in a microwave oven rather than conventional ovens because of the reduced cooking time required to heat foods in a microwave oven. Consumers also want to be provided with the opportunity to cook pre-packaged food products in the package in which they were purchased without the hassle of transferring the food from one container to the next. Consumers further want to be provided with pre-packaged microwave oven meals which allow a dinner with several different courses to be prepared at one time.

Unfortunately, when cooking foods in a microwave oven, foods which are preferably served tender and moist, such as vegetables, tend to be tough or dry in texture and consistency, while foods which are preferably served browned and crispy, such as breaded fish, tend to be soggy. In addition, microwave ovens do not evenly distribute heat to the product being cooked. This results in a cooked food product that may be very hot in one area, but cold in another area. Because of these problems, many people consider microwave cooking to be problematic and generally undesirable.

With regard to foods which are preferably served tender and moist, one method for improving the texture and consistency when cooking using a microwave oven is to use steam generated by the heated food product to assist in cooking the food. Cooking with steam not only provides moisture for the food being cooked, but also results in more consistent heating throughout the food product.

Specifically, a container using the steam generated by the heated food product to assist in cooking the food takes advantage of the ideal gas law, a distillation of several kinetic theories including Boyle's Law and Gay-Lussac's Law. More specifically, such containers take advantage of the proportional relationship between pressure and temperature when volume and number of gas molecules remain constant. This proportional relationship can be expressed as a mathematical equation, (P₂/P₁)=(T₂/T₁), where P₁ is the initial pressure, P₂ is the final pressure, T, is the initial temperature, and T₂ is the final temperature. Accordingly, any increase in pressure will result in a proportional increase in temperature that would not occur at ambient pressures. For example, if the pressure was to increases 1.2 fold (e.g., from 1 to 1.2 atmospheres), the temperature would also increase 1.2 fold (e.g., from 275 K to 330 K, which is an increase from 35° F. to 134° F.).

In order to steam cook a food product in a microwave oven, the steam must be retained within a cooking container; accordingly, the container must be at least partially sealed. When a sealed container is used to heat a food product contained therein, pressure rapidly builds as steam is generated from the heated food product. As heating continues, this pressure will continue to escalate until the container ruptures in some fashion, thereby relieving the pressure.

This relief often comes in the form of an explosion forcing an opening of the container and resulting in food being ejected therefrom. Not only does such an explosion create a mess, but it also undermines the attempt to use steam to cook the food product because the explosion causes a rapid release of the collected steam from the no longer sealed cooking environment. To avoid this problem, venting mechanisms may be provided to allow for controlled release of pressure and steam from the container.

With regard to foods which are preferably served browned and crispy, one method for improving the texture and consistency when cooking using a second peal away strip 34 is grasped and pealed away from the outer packaging 30, one or more openings 36 defined by the outer packaging 30 are revealed, each opening 36 being associated with a venting mechanism 22 such that, when venting occurs, the steam may escape through the opening 36.

Of course, the container of the present invention may take various forms as long as it includes a steaming compartment, having a sealed cooking environment and a venting mechanism, and a crisping compartment, having an open cooking environment and incorporating susceptor film within the volume defined by the compartment.

For example, FIG. 2 depicts an alternative embodiment of the present invention. In the container 110 depicted in FIG. 2, the steaming compartment 112 is discrete from the crisping 15 compartment 114 and includes a covering 118 sealed to a base 138 and at least one venting mechanism 122. The crisping compartment 114 includes a cooking bag 140, at least partially lined with susceptor film, having one or more apertures 124 defined therethrough. As depicted in FIG. 2, the compartments 112, 114 are preferably enclosed within a snuggly fitting outer packaging 130 having a first peal away strip 132, associated with the crisping compal tinent 114, and a second peal away strip 134, associated with the at least one venting mechanism 122 of the steaming compartment 112. The first peal away strip 132 may be grasped and pealed away from the outer packaging 130, forming an aperture (not shown) defined by the outer packaging 130. The second peal away strip 132, like that of the embodiment of the container depicted in FIG. 1, may be pealed away to reveal one or more openings 136, each associated with a venting mechanism 122 of the steaming compartment 112.

Of course, the embodiments depicted in the Figures are merely exemplary and it is contemplated that containers having a variety of structural features could be constructed without departing from the spirit and scope of the present invention. It will be obvious to those skilled in the art that other modifications may be made to the invention described herein without departing from the spirit and scope of the present invention. microwave oven is to use susceptors to assist in cooking the food, such as those described in U.S. Pat. No. 5,614,259, which is incorporated herein by this reference.

Susceptors are employed in the preparation of food products in microwave ovens to convert some of the microwave energy to heat in order to assist in cooking the food by conduction, convection and/or radiant heating, as well as microwave radiation. Specifically, susceptors are often used to assist in the preparation of food, which, when cooked desirably, should have a browned or crispy exterior surface. Susceptors are applied to the cooking surfaces of utensils, portions of packaged food products, and a food wrap for a food product.

Since susceptors are brought into contact with foods intended for human consumption, it is necessary to encapsulate the microwave interactive material within films or the like that are approved for contact with food, thus resulting in a multi-layer susceptor product (sometime referred to hereinafter as “susceptor film”). Customarily, the susceptor product comprises a base sheet, such as paper or cardboard, a thin film or foil of microwave interactive material, such as aluminum and other selected metals and alloys, and a heat resistant barrier film overlying the metal film or foil. The multi-layer sheet may then be wrapped around or placed adjacent food being packaged in a microwave cooking container to facilitate cooking of the food product.

Some microwave cooking containers have been designed to cook food using steam, and other microwave cooking containers have been designed to brown and crisp food with the assistance of susceptor products. However, neither of these containers can be used to desirably prepare a pre-packaged microwave oven meal having, for example, a vegetable course and a breaded fish course. If a steam cooking container were used, the breaded fish would become soggy, and, if a browning and crisping container were used, the vegetables would become tough and dry.

It is therefore the paramount object of the present invention to provide a microwave cooking container having separate compartments for crisping and steaming.

This and other objects and advantages of the present invention will become apparent upon a reading of the following description.

### DESCRIPTION OF THE DRAWINGS

FIG. 1 is a perspective view of an embodiment of a container made in accordance3 with the present invention.

FIG. 2 is a perspective view of an alternate embodiment of a container made in accordance with the present invention.

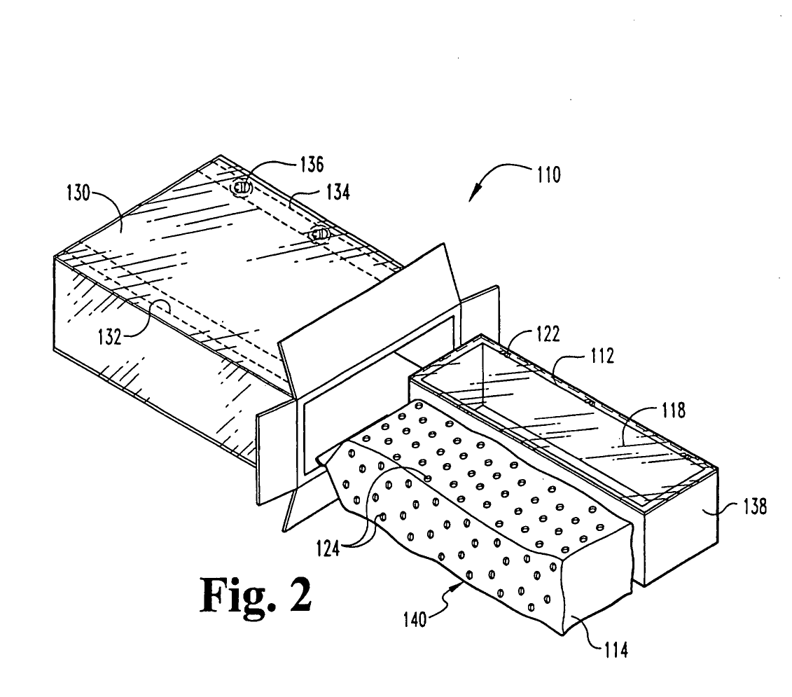

### DETAILED DESCRIPTION OF THE INVENTION

The present invention is a microwave cooking container having multiple compartments for crisping and steaming. Specifically, the container includes at least one steaming compartment and at least one crisping compartment.

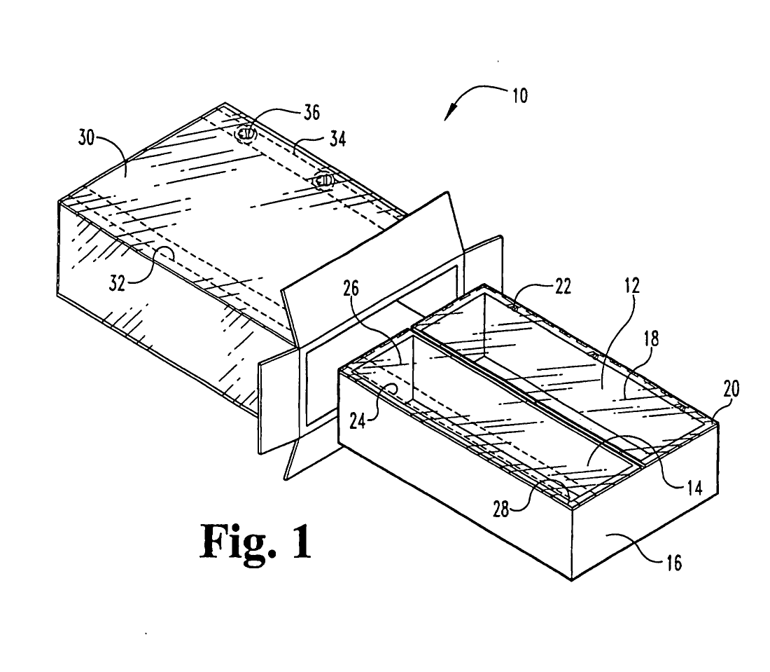

In the embodiment of the present invention depicted in FIG. 1, the container 10 includes a tray 16 having a steaming compaitinent 12 and a crisping compartment 14. With regard to the steaming compartment 12, because it is being used to steam cook a food product, the steam must be retained within the compartment 12 during the cooking process. Accordingly, the compartment 12 must have a sealed cooking environment such that it has a substantially fixed volume. There are various manners in which the compartment 12 may be sealed after food product has been positioned therein. For example, as shown in FIG. 1, a covering 18 may be sealed to an upper peripheral edge 20 of the compartment 12.

The steaming compartment 12 of the present invention is designed to maintain the fixed volume while being heated such that pressure builds within the volume, allowing for efficient steam cooking of the food product. However, as heating continues, this pressure will continue to escalate until the pressure is relieved. Without a controlled venting mechanism, this relief would come in the form of an explosion, forcing the covering 18 from the compartment 12, and possibly resulting in food being ejected from the compartment 12. The compartment 12 of the present invention avoids this problem by including at least one venting mechanism 22 to facilitate the controlled release of steam when a predetermined temperature and pressure has been reached. It is not important which type of venting mechanism is used, as long as it allows for controlled venting of the compartment 12. For example, the venting mechanism described in U.S. Pat. No. 6,559,431, which is incorporated herein by this reference, could be used.

With regard to the crisping compartment 14, susceptor film is incorporated within the volume defined by the compartment 14 to facilitate browning and crisping. For example, at least a portion of its inner surface (not shown) could be coated with susceptor film. Alternatively, at least one discrete piece of susceptor film may be placed within the volume defined by the compartment 14. Quite distinctly from the steaming compartment 12, the crisping compartment 14 preferably has an open cooking environment to allow moisture to escape from the compartment 14, keeping the food product from becoming soggy during preparation. An open cooking environment is one which does not have a fixed volume while the food product is being prepared (i.e., while the food product is being cooked in the microwave oven using the container 10 of the present invention).

After food product has been positioned in the crisping compartment 14, it is also preferably sealed to maintain the integrity of the food product during storage. However, an aperture (not shown) is created in the compartment 14 just prior to preparation to allow the moisture generated from the food product to escape. For example, as shown in FIG. 1, a covering 26 may be sealed to an upper peripheral edge 28 of the crisping compartment 14 after food product has been positioned therein. However, prior to preparation, an aperture-forming portion 24 of the covering 26 is preferably removed such that an aperture (not shown), defined by the covering 26, is created to allow moisture to escape the compartment 14.

Optionally, as shown in FIG. 1, the container 10 may also include an outer packaging 30. The outer packaging 30 preferably includes a first peal away strip 32 associated with the aperture-forming portion 24 of the covering 26. Specifically, it is preferred that the first peal away strip 32 be connected to the aperture-forming portion 24 of the covering 26 such that, when the first peal away strip 32 is grasped and pealed away from the outer packaging 30, the aperture-forming portion 24 of the covering 26 is also pealed away. In this manner, an aperture (not shown) defined by the covering 26 and the outer packaging 30 is created.

It is additionally preferred that the outer packaging 30 include a second peal away strip 34 associated with the at least one venting mechanism 22 of the steaming compartment 12. Specifically, it is preferred that, when the

1. A microwave cooking device for crisping and steaming food, comprising:
at least one steaming compartment having a sealed cooking environment and including at least one venting mechanism; and
at least one crisping compartment having an open cooking environment and including a susceptor film incorporated within a volume defined by the at least one crisping compartment.

2. The device of claim 1, wherein the at least one crisping compartment and the at least one steaming compartment are formed in a tray.

3. The device of claim 2, further including a covering sealed to the tray over the at least one steaming compartment.

4. The device of claim 3, wherein the covering is sealed to an upper peripheral edge of the tray surrounding the at least one steaming compartment.

5. The device of claim 1, wherein the susceptor film lines at least a portion of an inside surface of the volume defined by the at least one crisping compartment.

6. The device of claim 1, wherein at least one discrete piece of susceptor film may be placed within the volume defined by the at least one crisping compartment.

7. The device of claim 1, further including a covering for the at least one crisping compartment, the covering defining an aperture.

8. The device of claim 2, the at least one crisping compartment further including a covering heat sealed to the tray, the covering defining an aperture.

9. The device of claim 1, further including an outer packaging that surrounds the at least one crisping compartment and the at least one steaming compartment.

10. The device of claim 9, the outer packaging further including at least one peal away strip.

11. The device of claim 10, wherein the peal away strip defines an aperture when grasped and pealed away from the outer packaging.

12. The device of claim 1, wherein the at least one crisping compartment is a cooking bag.

13. The device of claim 12, wherein the cooking bag defines a plurality of apertures.

14. The device of claim 13, the cooking bag including an inner surface and an outer surface, wherein the inner surface is lined with a susceptor film.

15. A microwave cooking device for steaming and crisping food, comprising:
a tray defining at least one crisping compartment having an open cooking environment and at least one steaming compartment having a closed cooking environment, the at least one crisping compartment incorporating a susceptor and the at least one steaming compartment including a venting mechanism; and
an outer packaging surrounding the tray, wherein the outer packaging is constructed and arranged to enable moisture from the compartments to exit the microwave cooking device.

16. The device of claim 15, wherein moisture exits the outer packaging from an aperture formed by pealing away a peal away strip.

17. A microwave cooking device for steaming and crisping food, comprising: a cooking bag defining a plurality of apertures, wherein the cooking bag is lined with a susceptor film;
a tray defining a compartment covered with a sealed covering, wherein the covering includes a venting mechanism; and
an outer packaging surrounding the cooking bag and the tray, the outer packaging including at least one peal away strip, wherein pealing of the at least one peal away strip forms an aperture in the outer packaging.
